(19) United States
(12) Patent Application Publication
(10) Pub. No.: US 2011/0280308 A1
(43) Pub. Date: Nov. 17, 2011

(54) MOVING IMAGE ENCODING APPARATUS AND METHOD OF CONTROLLING THE SAME

(75) Inventors: Akihiro Oishi, Yokohama-shi (JP); Hiroaki Endo, Hachioji-shi (JP)

(73) Assignee: CANON KABUSHIKI KAISHA, Tokyo (JP)

(21) Appl. No.: 13/097,806

(22) Filed: Apr. 29, 2011

(30) Foreign Application Priority Data
May 12, 2010 (JP) 2010-110595

(51) Int. Cl. H04N 7/32

(52) U.S. Cl. 375/240.16; 375/E07.243

(57) ABSTRACT

There is provided a moving image encoding apparatus for performing motion compensation prediction encoding. The apparatus comprises, among other things: a calculation unit configured to calculate, for each of a plurality of motion vectors, a difference between an encoding target block image and a reference block image which exists at a position moved based on the motion vector from a position in a reference image corresponding to the predetermined position; and a selection unit configured to select one motion vector from the plurality of motion vectors such that reducing a code amount when the selected motion vector is encoded and reducing the difference corresponding to the selected motion vector are achieved in predetermined balance. The predetermined balance gives priority to reducing the difference over reducing the code amount as a minimum value of a plurality of differences calculated by the calculation unit becomes smaller.

### BACKGROUND OF THE INVENTION

1. Field of the Invention

The present invention relates to a moving image encoding apparatus and a method of controlling the same.

2. Description of the Related Art

A digital video camera is conventionally known well as a moving image encoding apparatus which captures an object image and compress-codes and records the moving image data obtained by image capturing. In recent years, a recording medium to be used to record moving image data is shifting from a conventional magnetic tape to a disk medium or semiconductor memory having high convenience such as random accessibility. MPEG-2 has become popular as the encoding method, which can compress moving image data at a high compression ratio by encoding using inter-frame motion prediction (motion compensation prediction encoding). H.264 capable of compressing moving image data at a higher compression ratio is also used recently.

The moving image encoding apparatus for performing motion compensation prediction encoding searches for a motion vector between frames in each macroblock (MC block) that is a unit of encoding obtained by dividing a frame image, and performs motion compensation, thereby decreasing the information amount. The motion vector search is done in consideration of the degree of similarity between the encoding target macroblock image (encoding target image) and a reference block image (reference image). That is, to decrease the information amount, a motion vector that increases the degree of similarity between the encoding target image and the reference image (i.e., that makes the difference image to be encoded small) is suitable.

However, when using motion compensation, it is necessary to encode and record the motion vector as well as the difference image. Hence, to decrease the information amount as a whole, not only the degree of similarity between the encoding target image and the reference image but also the code amount of the motion vector itself needs to be taken into consideration. Generally, a motion vector is searched for using an evaluation function

C=D+λR (1)

where D is the difference between the encoding target image and the reference image, R is the code amount of the motion vector, and λ is the coefficient. Hence, C represents the encoding cost of the used (candidate) motion vector. The difference D is expressed using the sum of squared differences, the sum of absolute differences, or the like. A quantization step is generally used as the coefficient λ.

Meanwhile, the code amount R of the motion vector is calculated based on the difference between the motion vector and the motion vectors of macroblocks around the encoding target macroblock. Therefore, when the motion vectors of a plurality of macroblocks are to be searched for in parallel, it may be impossible to correctly calculate the code amount R of a motion vector because the motion vector of a peripheral macroblock has not yet been selected. A technique of coping with this is described in, for example, Japanese Patent Laid-Open No. 2008-154072.

When searching for a motion vector based on equation (1) described above, a motion vector that does not minimize the difference D may be selected. That is, a motion vector different from that closest to the actual motion (change) in the moving image may be selected, resulting in degradation in the quality of the encoded moving image.

In general, the image quality degradation is not so clearly visually recognized. However, in a moving image with a small change (for example, a moving image that shows cloud in the blue sky moves while maintaining its shape), the image quality degradation is readily visually recognized (for example, the afterimage of cloud is recognized in the decoded image).

In the conventional technique, since the coefficient λ is fixed, the code amount of the motion vector is taken into consideration with the same weight in any moving image. As a result, a motion vector that is not so close to the actual motion of the moving image may be selected even for a moving image whose image quality degradation is readily recognized, and user satisfaction for the image quality may lower. Japanese Patent Laid-Open No. 2008-154072 does not consider this problem, either.

### SUMMARY OF THE INVENTION

The present invention has been made in consideration of the above-described situation, and provides a technique of selecting a motion vector in motion compensation prediction encoding so as to suppress image quality degradation in a moving image including a small change.

According to a first aspect of the present invention, there is provided a moving image encoding apparatus for performing motion compensation prediction encoding for an encoding target block image existing at a predetermined position of an encoding target image using one motion vector selected from a plurality of motion vectors serving as candidates, comprising: a calculation unit configured to calculate, for each of the plurality of motion vectors, a difference between the encoding target block image and a reference block image which exists at a position moved based on the motion vector from a position in a reference image corresponding to the predetermined position; a selection unit configured to select one motion vector from the plurality of motion vectors such that reducing a code amount when the selected motion vector is encoded and reducing the difference corresponding to the selected motion vector are achieved in predetermined balance; and an encoding unit configured to encode the motion vector selected by the selection unit and the difference calculated for the motion vector by the calculation unit, wherein the predetermined balance gives priority to reducing the difference over reducing the code amount as a minimum value of a plurality of differences calculated by the calculation unit becomes smaller, and gives priority to reducing the code amount over reducing the difference as the minimum value becomes larger.

According to a second aspect of the present invention, there is provided a moving image encoding apparatus for performing motion compensation prediction encoding for an encoding target block image existing at a predetermined position of an encoding target image using one motion vector selected from a plurality of motion vectors serving as candidates, comprising: a first calculation unit configured to, for each of the plurality of motion vectors, reduce the encoding target block image and a reference block image which exists at a position moved based on the motion vector from a position in a reference image corresponding to the predetermined position and calculate a difference between the reduced block image and the reduced reference block image; a first selection unit configured to select one motion vector from the plurality of motion vectors such that reducing a code amount when the selected motion vector is encoded and reducing the difference corresponding to the selected motion vector are achieved in first balance; a second calculation unit configured to calculate, for, out of the plurality of motion vectors, each of the motion vectors whose distances from a position indicated by the motion vector selected by the first selection unit are equal to or smaller than a threshold, a difference between the block image and the reference block image; a second selection unit configured to select one motion vector from the motion vectors whose distances from the position indicated by the motion vector selected by the first selection unit are equal to or smaller than the threshold such that reducing the code amount when the selected motion vector is encoded and reducing the difference corresponding to the selected motion vector are achieved in second balance; and an encoding unit configured to encode the motion vector selected by the second selection unit and the difference calculated for the motion vector by the second calculation unit, wherein the first balance gives priority to reducing the difference over reducing the code amount as a minimum value of a plurality of differences calculated by the first calculation unit becomes smaller, and gives priority to reducing the code amount over reducing the difference as the minimum value becomes larger.

According to a third aspect of the present invention, there is provided a method of controlling a moving image encoding apparatus for performing motion compensation prediction encoding for an encoding target block image existing at a predetermined position of an encoding target image using one motion vector selected from a plurality of motion vectors serving as candidates, comprising: a calculation step of calculating, for each of the plurality of motion vectors, a difference between the encoding target block image and a reference block image which exists at a position moved based on the motion vector from a position in a reference image corresponding to the predetermined position; a selection step of selecting one motion vector from the plurality of motion vectors such that reducing a code amount when the selected motion vector is encoded and reducing the difference corresponding to the selected motion vector are achieved in predetermined balance; and an encoding step of encoding the motion vector selected in the selection step and the difference calculated for the motion vector in the calculation step, wherein the predetermined balance gives priority to reducing the difference over reducing the code amount as a minimum value of a plurality of differences calculated in the calculation step becomes smaller, and gives priority to reducing the code amount over reducing the difference as the minimum value becomes larger.

According to a fourth aspect of the present invention, there is provided a method of controlling a moving image encoding apparatus for performing motion compensation prediction encoding for an encoding target block image existing at a predetermined position of an encoding target image using one motion vector selected from a plurality of motion vectors serving as candidates, comprising: a first calculation step of, for each of the plurality of motion vectors, reducing the encoding target block image and a reference block image which exists at a position moved based on the motion vector from a position in a reference image corresponding to the predetermined position and calculating a difference between the reduced block image and the reduced reference block image; a first selection step of selecting one motion vector from the plurality of motion vectors such that reducing a code amount when the selected motion vector is encoded and reducing the difference corresponding to the selected motion vector are achieved in first balance; a second calculation step of calculating, for, out of the plurality of motion vectors, each of motion vectors whose distances from a position indicated by the motion vector selected in the first selection step are equal to or smaller than a threshold, a difference between the block image and the reference block image; a second selection step of selecting one motion vector from the motion vectors whose distances from the position indicated by the motion vector selected in the first selection step are equal to or smaller than the threshold such that reducing the code amount when the selected motion vector is encoded and reducing the difference corresponding to the selected motion vector are achieved in second balance; and an encoding step of encoding the motion vector selected in the second selection step and the difference calculated for the motion vector in the second calculation step, wherein the first balance gives priority to reducing the difference over reducing the code amount as a minimum value of a plurality of differences calculated in the first calculation step becomes smaller, and gives priority to reducing the code amount over reducing the difference as the minimum value becomes larger.

With the above-described arrangement, according to the present invention, it is possible to select a motion vector in motion compensation prediction encoding so as to suppress image quality degradation in a moving image including a small change.

Further features of the present invention will become apparent from the following description of exemplary embodiments with reference to the attached drawings.

### BRIEF DESCRIPTION OF THE DRAWINGS

FIG. 1 is a block diagram showing an example of the arrangement of a moving image encoding apparatus 100 according to an embodiment;

FIG. 2 is a flowchart illustrating processing of searching for the minimum value of the difference between a block image and a reference block image;

FIG. 3 is a flowchart illustrating processing of deciding a coefficient λ (first embodiment);

FIG. 4 is a flowchart illustrating motion vector selection processing based on the SAD calculated in FIG. 2 and the coefficient λ decided in FIG. 3;

FIG. 5 is a flowchart illustrating processing of deciding a coefficient λ (second embodiment);

FIG. 6 is a block diagram showing the arrangement of a motion vector selection unit 103 (third embodiment); and

FIG. 7 is a block diagram showing the arrangement of a motion vector selection unit 103 (fourth embodiment).

### DESCRIPTION OF THE EMBODIMENTS

Embodiments of the present invention will now be described with reference to attached drawings. It should be noted that the technical scope of the present invention is defined by claims, and is not limited by each embodiment described below. In addition, not all combinations of the features described in the embodiments are necessarily required for realizing the present invention.

### First Embodiment

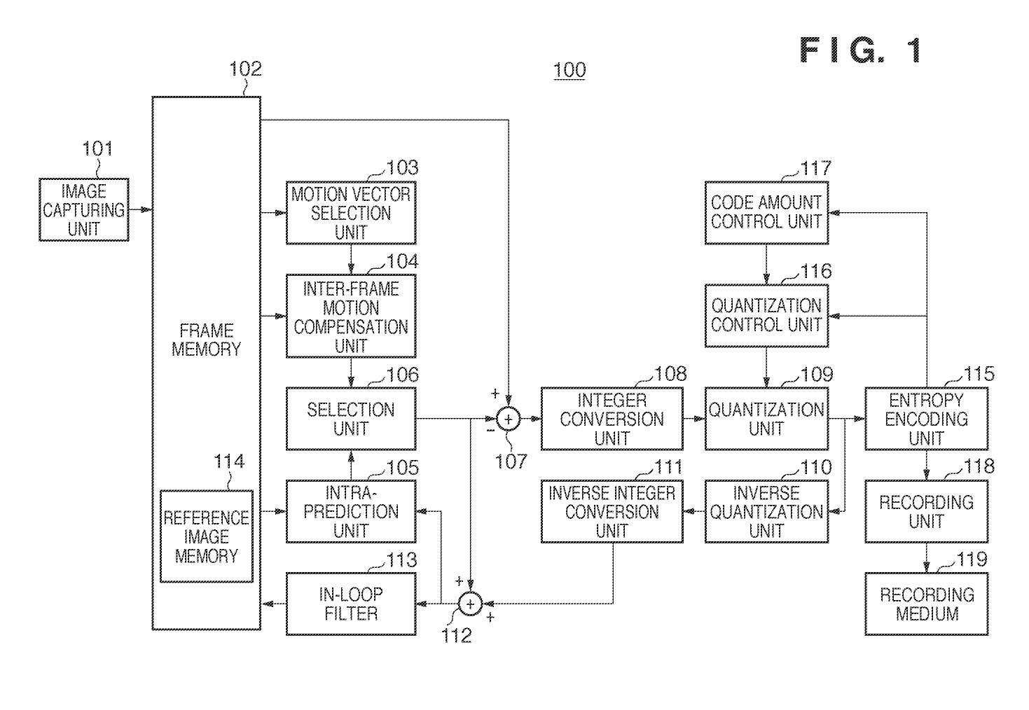

FIG. 1 is a block diagram showing an example of the arrangement of a moving image encoding apparatus 100 according to the embodiment. The apparatus includes: an image capturing unit 101 including a camera unit with a lens, an image sensor, and the like; a frame memory 102; a motion vector selection unit 103 that searches for motion vectors; and an inter-frame motion compensation unit 104 that generates inter-predicted image data based on the motion vectors. The apparatus also includes an intra-prediction unit 105 that generates intra-predicted image data, a selection unit 106 that selects one of the inter-predicted image data and the intra-predicted image data, a subtracter 107, an integer conversion unit 108, and a quantization unit 109. The apparatus also includes an inverse quantization unit 110, an inverse integer conversion unit 111, an adder 112, an in-loop filter 113, an entropy encoding unit 115, a quantization control unit 116, a code amount control unit 117, and a recording unit 118. A recording medium 119 is attached to the moving image encoding apparatus 100. The frame memory 102 includes a reference image memory 114 that stores a reference image to be used for inter-prediction.

The blocks of the moving image encoding apparatus 100 shown in FIG. 1 may be constituted by hardware using dedicated logic circuits and memories. Alternatively, the blocks may be constituted using software by causing a CPU to execute processing programs stored in a memory.

Moving image data obtained by image capturing of the image capturing unit 101 is stored in the frame memory 102 as the first frame, second frame, third frame, . . . sequentially in the generation order. The image data is extracted from the frame memory 102 in the encoding order of, for example, third frame, first frame, second frame, . . . .

Encoding methods include intra-prediction encoding that encodes only image data within frames and inter-prediction encoding that encodes also predicted image data between frames. Pictures used in inter-prediction encoding are a P picture that makes a prediction between the unit of motion compensation (MC block) and one reference frame and a B picture that makes predictions between the MC block and two reference frames. On the other hand, intra-prediction encoding uses an I picture. Note that the frames are encoded in the order different from the frame input order so as to enable not only prediction for a past frame but also prediction (backward prediction) with respect to a future frame in terms of time.

When performing intra-prediction encoding, the image data of an encoding target block, which is used as a unit of encoding, is read out from the frame memory 102 and input to the intra-prediction unit 105. In this embodiment, one encoding target block is formed from 16×16 pixels. The data of pixels adjacent to the readout encoding target block are also read out from the frame memory 102 and input to the intra-prediction unit 105.

The intra-prediction unit 105 performs block matching between the encoding target block and a plurality of intra-predicted image data generated from the data of the pixels adjacent to the encoding target block. Intra-predicted image data having the highest correlation is selected and output to the selection unit 106. When performing intra-prediction encoding, the selection unit 106 always selects the output from the intra-prediction unit 105 and outputs the intra-predicted image data to the subtracter 107.

The subtracter 107 receives the intra-predicted image data and the block image data of the encoding target image read out from the frame memory 102, and outputs, to the integer conversion unit 108, the difference image data of pixel values between the block image of the encoding target image and the intra-predicted image data. The integer conversion unit 108 performs integer conversion for the input difference image data of pixel values. The quantization unit 109 quantizes the signal that has undergone the integer conversion of the integer conversion unit 108.

The entropy encoding unit 115 entropy-encodes conversion coefficients quantized by the quantization unit 109, and outputs them to the recording unit 118 as a data stream. Quantization coefficients in the quantization unit 109 are calculated by the quantization control unit 116 based on a code amount generated by the entropy encoding unit 115 and a target code amount set by the code amount control unit 117. The recording unit 118 records, in the recording medium 119, the data stream output from the entropy encoding unit 115.

The conversion coefficients quantized by the quantization unit 109 are also input to the inverse quantization unit 110. The inverse quantization unit 110 inversely quantizes the input conversion coefficients. The inverse integer conversion unit 111 performs inverse integer conversion processing for the inversely quantized signal.

The adder 112 receives and adds the data that has undergone the inverse integer conversion processing and the intra-predicted image data generated by the intra-prediction unit 105. The added data is decoded reconstructed image data which is input to the intra-prediction unit 105 and used to generate intra-predicted image data. The reconstructed image data is also subjected to encoding distortion reduction processing by the in-loop filter 113 and is stored in the reference image memory 114 as reference image data to be used in inter-prediction encoding to be described later.

On the other hand, when performing inter-prediction encoding, the block image of an encoding target image, which is used as a unit of encoding, is read out from the frame memory 102 and input to the motion vector selection unit 103. The motion vector selection unit 103 reads out reference image data from the reference image memory 114, selects motion vectors based on the reference image and the block image of the encoding target image, and notifies the inter-frame motion compensation unit 104 of them.

The inter-frame motion compensation unit 104 generates inter-predicted image data using the motion vectors selected by the motion vector selection unit 103 and the reference image obtained from the frame memory 102, and supplies the inter-predicted image data to the selection unit 106 together with the motion vectors. When performing inter-prediction encoding, the selection unit 106 selects the inter-predicted image data and supplies it to the subtracter 107.

Note that in some frames, inter-prediction or intra-prediction can be selected for each encoding target block. When performing intra-prediction, the above-described operation is performed, and the intra-prediction result is sent to the selection unit 106. When performing inter-prediction, the selection unit 106 selects the inter-predicted image data from the inter-frame motion compensation unit 104 and outputs it to the subtracter 107. Based on the inter-prediction result from the motion vector selection unit 103 and the intra-prediction result from the intra-prediction unit 105, the selection unit 106 can select, for example, a prediction method which produces a smaller difference value.

The subtracter 107 calculates the difference between the predicted image and the block image of the encoding target image so as to generate difference image data. The difference image data is output to the integer conversion unit 108. Subsequent processing is the same as that in the above-described intra-prediction encoding.

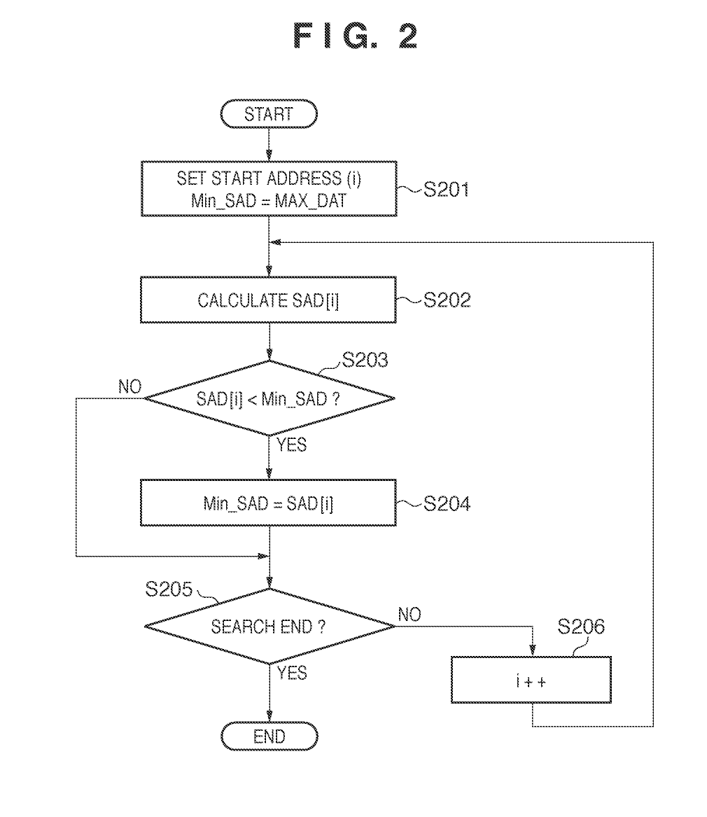

Motion vector selection processing by the motion vector selection unit 103 will be described next in detail with reference to FIGS. 2 to 4. The motion vector selection unit 103 selects one of a plurality of motion vectors serving as candidates (candidate vectors). The set of candidate vectors is defined to cover a predetermined range of a reference image based on the position of the encoding target macroblock image (block image). In the following explanation, a block image which exists at a position moved based on a motion vector from the position in the reference image corresponding to the position of the encoding target block image will be referred to as a reference block image. Note that the macroblock is obtained by dividing the encoding target image.

FIG. 2 is a flowchart illustrating processing of searching for the minimum value of the difference between the reference block image and the encoding target block image existing at a predetermined position of the encoding target image. In this embodiment, SAD (Sum of Absolute Differences) is used to represent a difference.

In step S201, the motion vector selection unit 103 sets a start address i for a vector search (for example, 0 is substituted for i, and an (i+1)th candidate vector is used in the following processing of steps S202 to S204). In addition, the motion vector selection unit 103 sets a sufficiently large value MAX_DAT in Min_SAD that is a variable representing the minimum value of SAD.

In step S202, the motion vector selection unit 103 calculates SAD at the address i (SAD[i]). More specifically, the motion vector selection unit 103 calculates SAD between the encoding target block image and a reference block image selected in accordance with the (i+1)th candidate vector.

In step S203, the motion vector selection unit 103 determines whether SAD[i] is smaller than Min_SAD. If SAD[i] is smaller than Min_SAD, the motion vector selection unit 103 substitutes SAD[i] for Min_SAD in step S204. If SAD[i] is not smaller than Min_SAD, the process skips step S204 and advances to step S205.

In step S205, the motion vector selection unit 103 determines whether SAD calculation has ended for all candidate vectors. If the calculation has ended, the processing of the flowchart ends. Otherwise, the motion vector selection unit 103 increments the address by one in step S206 and returns the process to step S202.

With the above-described processing, minimum SAD for the candidate vector set is calculated. The fact that the minimum SAD is small indicates that the change in the encoding target moving image is small (for example, a cloud in the blue sky stands still or moves while maintaining its shape). Conversely, the fact that the minimum SAD is large indicates that the change in the encoding target moving image is large (for example, the shape of a cloud in the blue sky changes, or the moving image expresses water that is a constantly changing encoding target). The motion vector selection unit 103 then decides a coefficient λ based on the minimum SAD for an equation to be used to select a motion vector.

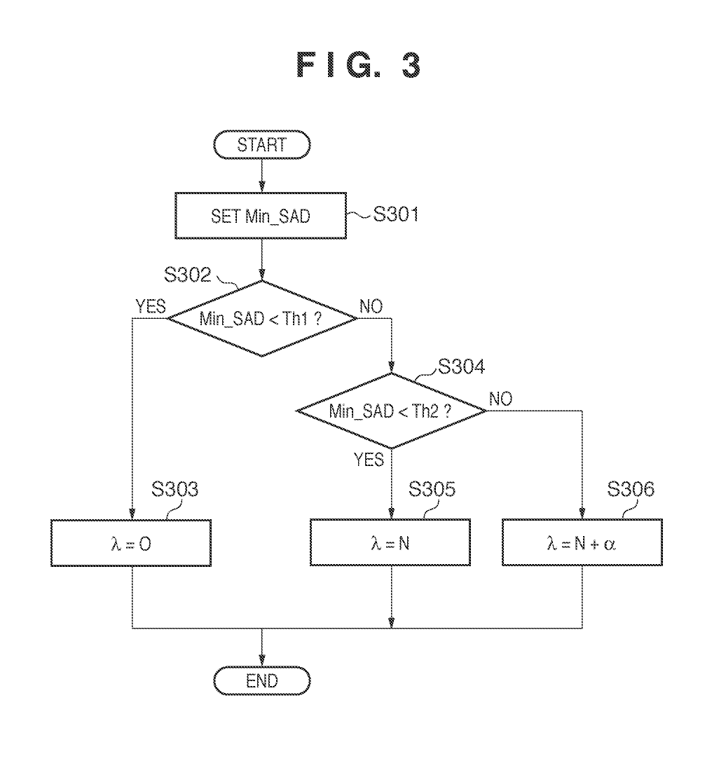

FIG. 3 is a flowchart illustrating processing of deciding the coefficient λ. In step S301, the motion vector selection unit 103 sets Min_SAD calculated in FIG. 2. In step S302, the motion vector selection unit 103 determines whether Min_SAD is smaller than a threshold Th1. If Min_SAD is smaller, the process advances to step S303. Otherwise, the process advances to step S304.

In step S303, the motion vector selection unit 103 substitutes 0 for the coefficient λ and ends the processing of the flowchart. As is understandable from equation (2) to be described later, when the coefficient λ is 0, a motion vector is selected based on only SAD without considering the vector code amount. Hence, image quality improvement is given higher priority over reduction of the total information amount.

In step S304, the motion vector selection unit 103 determines whether Min_SAD is smaller than a threshold Th2. If Min_SAD is smaller, the process advances to step S305. Otherwise, the process advances to step S306.

In step S305, the motion vector selection unit 103 substitutes N for the coefficient λ and ends the processing of the flowchart. Note that N is a value decided based on a quantization step used in an encoded picture. That is, when Th1≦Min_SAD<Th2, the code amount of the motion vector to be taken into consideration is weighted by the coefficient N.

In step S306, the motion vector selection unit 103 substitutes (N+α) (α>0) for the coefficient λ and ends the processing of the flowchart. In this case, the code amount of the motion vector to be taken into consideration is multiplied by a weight larger than in the case where Th1≦Min_SAD<Th2. That is, when the motion of the moving image is large (when Min_SAD≧Th2), degradation in image quality is hard to recognize in general. For this reason, reduction of the total information amount is given higher priority over image quality improvement.

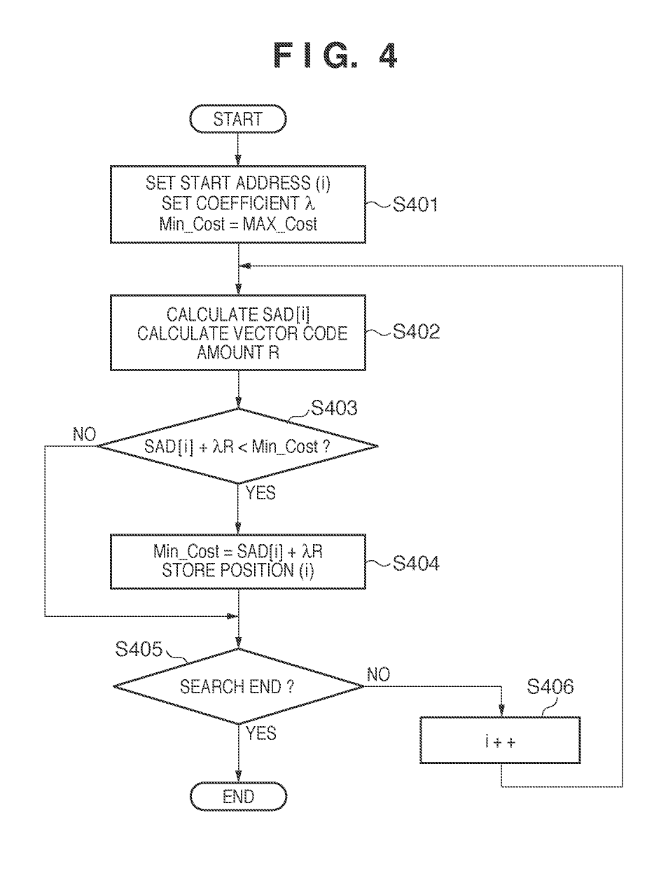

FIG. 4 is a flowchart illustrating motion vector selection processing based on the SAD calculated in FIG. 2 and the coefficient λ decided in FIG. 3. In step S401, the motion vector selection unit 103 sets the start address i for a vector search (for example, 0 is substituted for i, and an (i+1)th candidate vector is used in the following processing of steps S402 to S404). In addition, the motion vector selection unit 103 sets the coefficient λ decided in FIG. 3. The motion vector selection unit 103 also sets a sufficiently large value MAX_Cost in Min_Cost that is a variable representing the minimum value of the encoding cost.

In step S402, the motion vector selection unit 103 calculates SAD at the address i (SAD[i]) and a code amount R of the motion vector at the address i. As the SAD[i], the value calculated in step S202 of FIG. 2 is reusable.

In step S403, the motion vector selection unit 103 determines whether the encoding cost when the motion vector at the address i is selected is smaller than Min_Cost. The encoding cost is given by

Cost=SAD[i]+λR (2)

When (encoding cost) <Min_Cost, the process advances to step S404. Otherwise, the process advances to step S405.

In step S404, the motion vector selection unit 103 substitutes the encoding cost calculated by equation (2) for Min_Cost. The motion vector selection unit 103 also stores the address i at this time (if an address is already stored, the motion vector selection unit 103 updates the stored address to the address i at this time).

In step S405, the motion vector selection unit 103 determines whether encoding cost calculation has ended for all candidate vectors. If the calculation has ended, the processing of the flowchart ends. Otherwise, the motion vector selection unit 103 increments the address by one in step S406 and returns the process to step S402.

With the above-described processing, the motion vector to be finally used for the encoding target block image in motion compensation prediction encoding is selected from the candidate vector set. That is, a motion vector corresponding to the address i (the address finally stored in step S404) stored at the timing the processing of the flowchart of FIG. 4 has ended is selected.

In the above description, detailed difference expressions, thresholds, equations, and the like such as SAD, Th1, Th2, and equation (2) have been mentioned. However, this embodiment is not limited by such a detailed mention. In this embodiment, it is important to select a motion vector such that reducing the difference between the encoding target block image and the reference block image and reducing the code amount of the motion vector are achieved in predetermined balance. The predetermined balance gives priority to reducing the difference over reducing the code amount of the motion vector as the minimum value of the difference becomes smaller, and gives priority to reducing the code amount of the motion vector over reducing the difference as the minimum value of the difference becomes larger.

Hence, in this embodiment, for example, SATD (Sum of Absolute Transformed Differences) may be used in place of SAD. Additionally, the coefficient λ may be decided using not Th1 and Th2 in FIG. 3 but a function λ=f(Min_SAD) (the smaller SAD is, the smaller λ is).

According to the embodiment with the above-described arrangement, it is possible to select a motion vector in motion compensation prediction encoding so as to suppress degradation in image quality of a moving image including a small change.

### Second Embodiment

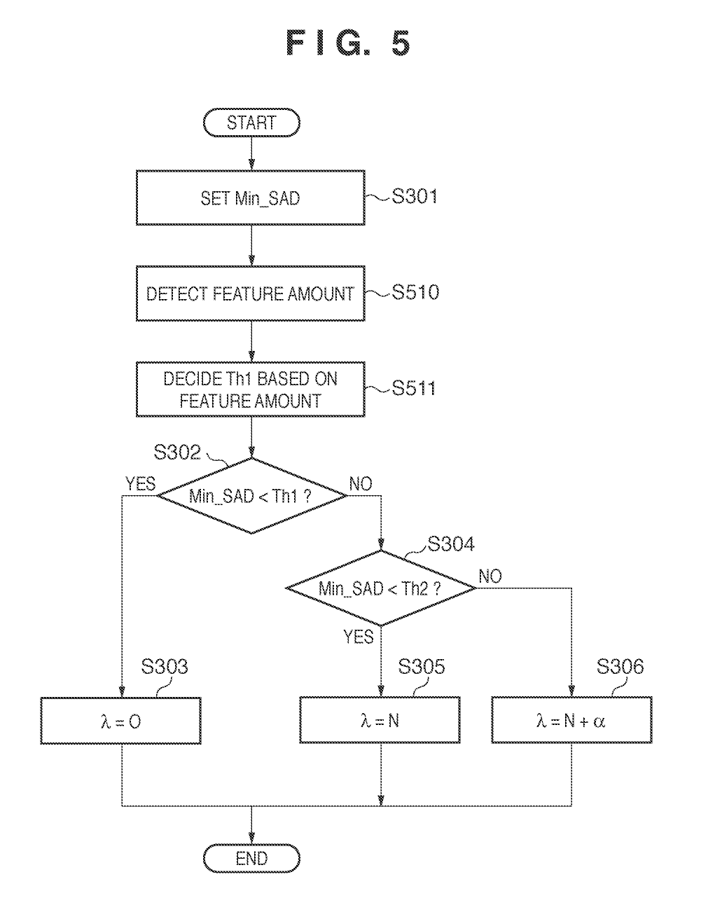

In the second embodiment, the feature amount of an encoding target block image is used to decide a coefficient λ. The second embodiment is the same as the first embodiment except that the processing shown in FIG. 3 is replaced with processing shown in FIG. 5. The second embodiment will be described below with reference to FIG. 5. The same step numbers as in FIG. 3 denote the same or similar processes in FIG. 5, and a description thereof will not be repeated.

In step S510, a motion vector selection unit 103 detects the feature amount of an encoding target block image. The feature amount represents the degree of variation between the pixels of the encoding target block image. In this embodiment, a variance is used as the feature amount. Alternatively, the average value, dynamic range, or the like of luminance values may be used. In step S511, the motion vector selection unit 103 decides the value of a threshold Th1 based on the variance.

The variance used as the feature amount of the macroblock correlates with the degree of encoding difficulty. The numerical value becomes larger as the image complexity increases. The numerical value becomes smaller if the image is flatter. An image with a large variance tends to make SAD at a wrong position large in motion detection. In an image with a small variance, even SAD at a wrong position is not so large in motion detection. In addition, SAD at a wrong position may be minimized due to noise or the like.

For this reason, in the image with the small variance, a smaller numerical value is substituted for Th1, and the coefficient λ is set to a value other than 0. In other words, the priority tendency of “balance that gives priority to reducing the difference over reducing the code amount of the motion vector as the minimum value of the difference becomes smaller, and gives priority to reducing the code amount of the motion vector over reducing the difference as the minimum value of the difference becomes larger” described in the first embodiment is weakened.

### Third Embodiment

In the third embodiment, an arrangement that speeds up motion vector selection by parallelizing some processes will be described.

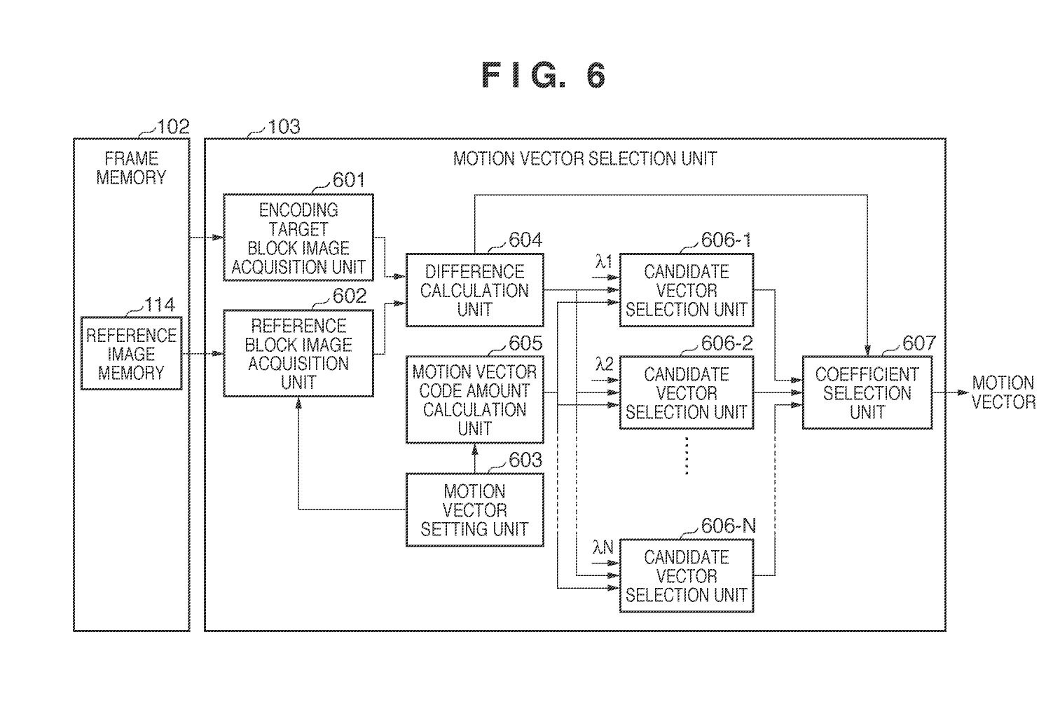

FIG. 6 is a block diagram showing the arrangement of a motion vector selection unit 103 according to the third embodiment. Referring to FIG. 6, an encoding target block image acquisition unit 601, a reference block image acquisition unit 602, a motion vector setting unit 603, and a difference calculation unit 604 calculate SAD for each of a plurality of motion vectors, as in the first embodiment (see FIG. 2).

More specifically, the encoding target block image acquisition unit 601 acquires an encoding target block image from a frame memory 102. The reference block image acquisition unit 602 acquires a reference block image from a reference image memory 114 in accordance with a motion vector set by the motion vector setting unit 603. The motion vector setting unit 603 sequentially sets, in the reference block image acquisition unit 602, each candidate vector selected from the first set of candidate vectors. The first set of candidate vectors corresponds to the candidate vector set in the first embodiment. The difference calculation unit 604 calculates the difference (in this case, SAD) between the block image acquired by the encoding target block image acquisition unit 601 and the reference block image acquired by the reference block image acquisition unit 602. The difference calculation unit 604 outputs the calculated SAD to N candidate vector selection units 606-1, 606-2, . . . , 606-N (candidate selection units). The difference calculation unit 604 also outputs the calculated SAD to a coefficient selection unit 607. In this case, the difference calculation unit 604 sequentially outputs each calculated SAD before the SAD calculation is completed for all motion vectors of the first set. That is, the difference calculation unit 604 outputs SAD[0] when it has been calculated, and outputs SAD[1] when it has been calculated.

Parallel with the SAD calculation, the motion vector setting unit 603 notifies a motion vector code amount calculation unit 605 of the motion vector set in the reference block image acquisition unit 602. The motion vector code amount calculation unit 605 calculates the code amount of the set motion vector and outputs it to the candidate vector selection units 606-1, 606-2, . . . , 606-N. Like the SAD output by the difference calculation unit 604, the motion vector code amount calculation unit 605 sequentially outputs each calculated code amount.

Each of the candidate vector selection units 606-1, 606-2, . . . , 606-N selects a motion vector with the minimum encoding cost from the first set of candidate vectors in accordance with the procedure described with reference to FIG. 4. However, unlike the first embodiment, different values (λ1, λ2, . . . , λN) are set for the candidate vector selection units 606-1, 606-2, . . . , 606-N, respectively, in advance as the coefficient λ. Since each of the candidate vector selection units 606-1, 606-2, . . . , 606-N selects one motion vector, N motion vectors are finally selected. The N motion vectors will be referred to as the second set of candidate vectors.

The coefficient selection unit 607 searches for Min_SAD from the SADs output from the difference calculation unit 604. The coefficient selection unit 607 selects one of the coefficients λ1, λ2, . . . , λN based on Min_SAD. More specifically, assume that λ1<λ2< . . . <λN. In this case, when Min_SAD is smaller than a threshold Th1, the coefficient selection unit 607 selects λ1. When Min_SAD is smaller than a threshold Th2, the coefficient selection unit 607 selects λ2. That is, the coefficient is selected based on (N−1) thresholds. Next, the coefficient selection unit 607 selects, out of the second set of candidate vectors, the motion vector selected by the candidate vector selection unit corresponding to the selected coefficient as the motion vector to be finally used. For example, when the coefficient λ2 is selected, the coefficient selection unit 607 selects the motion vector selected by the candidate vector selection unit 606-2 as the motion vector to be finally used.

As described above, the coefficients are set in the candidate vector selection units 606-1, 606-2, . . . , 606-N in advance, and calculated SADs and code amounts are sequentially output. Hence, each of the candidate vector selection units 606-1, 606-2, . . . , 606-N can calculate the encoding cost in parallel to the SAD calculation (see step S404 of FIG. 4). In other words, according to the third embodiment, since the motion vector selection unit 103 includes the plurality of candidate vector selection units 606-1, 606-2, . . . , 606-N, the processing in FIG. 2 and that in FIG. 4 are parallelized. Hence, motion vector selection speeds up.

### Fourth Embodiment

In the fourth embodiment, an arrangement that speeds up processing by combining a rough search and an advanced search will be described.

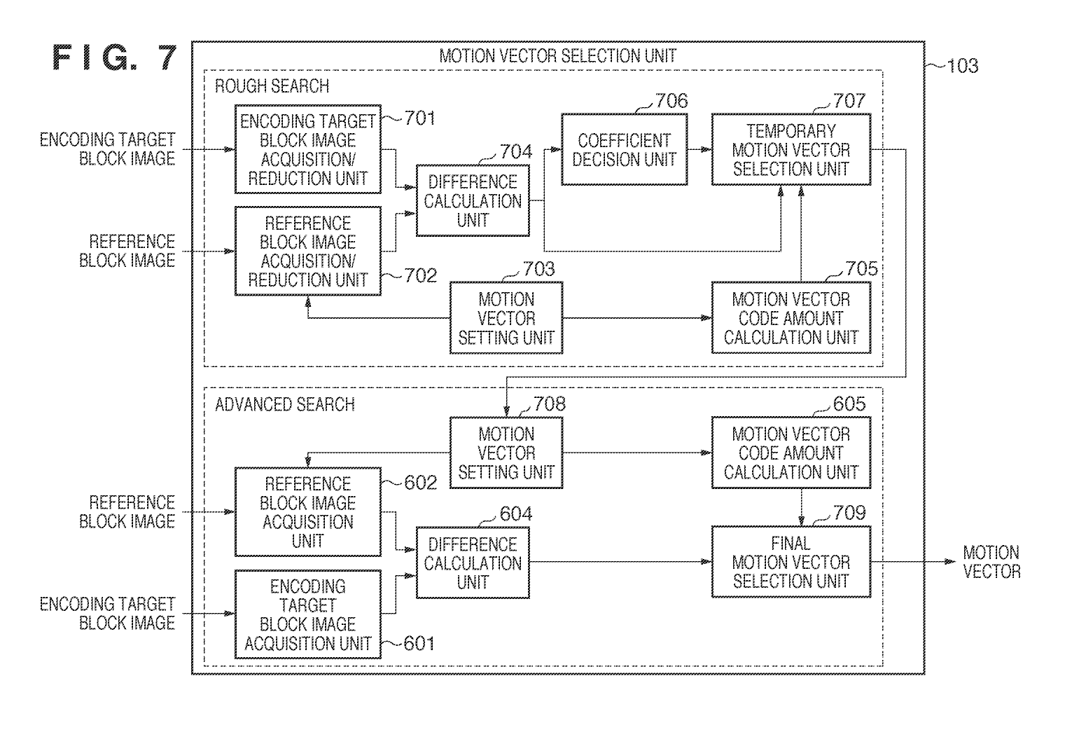

FIG. 7 is a block diagram showing the arrangement of a motion vector selection unit 103 according to the fourth embodiment. The same reference numerals as in FIG. 6 denote blocks having the same or similar functions in FIG. 7, and a description thereof will not be repeated.

An encoding target block image acquisition/reduction unit 701, a reference block image acquisition/reduction unit 702, a motion vector setting unit 703, and a difference calculation unit 704 function as a first calculation unit which calculates SAD for each of a plurality of motion vectors and searches for Min_SAD, as in the first embodiment (see FIG. 2). However, the encoding target block image acquisition/reduction unit 701 reduces the acquired block image. The reference block image acquisition/reduction unit 702 reduces the acquired reference block image. Since the process target images are reduced, the SAD calculation processing speeds up.

A coefficient decision unit 706 decides a coefficient λ, as in the first embodiment (see FIG. 3). A motion vector code amount calculation unit 705 and a temporary motion vector selection unit 707 function as a first selection unit which selects one motion vector from the candidate vector set in consideration of predetermined balance (first balance), as in the first embodiment (see FIG. 4). The temporary motion vector selection unit 707 notifies a motion vector setting unit 708 of the selected motion vector.

The motion vector setting unit 708 sets a motion vector in a reference block image acquisition unit 602 for each motion vector of the candidate vector set whose distance from the position indicated by the motion vector sent from the temporary motion vector selection unit 707 is equal to or smaller than a threshold. An encoding target block image acquisition unit 601, a reference block image acquisition unit 602, a difference calculation unit 604, and the motion vector setting unit 708 function as a second calculation unit. The motion vector setting unit 708 notifies a motion vector code amount calculation unit 605 of the set motion vector.

The motion vector code amount calculation unit 605 and a final motion vector selection unit 709 function as as a second selection unit which selects a motion vector from the motion vectors of the candidate vector set whose distances from the position indicated by the motion vector sent from the temporary motion vector selection unit 707 are equal to or smaller than the threshold. Detailed processing is the same as in the first embodiment. In the fourth embodiment, however, the coefficient λ is a preset value (alternatively, a value decided by the coefficient decision unit 706 may be used). The balance between reducing the difference between the encoding target block image and the reference block image and reducing the code amount of the motion vector may be considered as second balance different from the first balance. In addition, the search targets include not the whole candidate vector set but the motion vectors whose distances from the position indicated by the motion vector sent from the temporary motion vector selection unit 707 are equal to or smaller than the threshold.

With this processing, the motion vector search range for an unreduced image is limited to the neighborhood of the motion vector selected by the motion vector setting unit 708. Hence, the motion vector selection processing speeds up.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-110595, filed on May 12, 2010, which is hereby incorporated by reference herein in its entirety.

What is claimed is:

1. A moving image encoding apparatus for performing motion compensation prediction encoding for an encoding target block image existing at a predetermined position of an encoding target image using one motion vector selected from a plurality of motion vectors serving as candidates, comprising:
a calculation unit configured to calculate, for each of the plurality of motion vectors, a difference between the encoding target block image and a reference block image which exists at a position moved based on the motion vector from a position in a reference image corresponding to the predetermined position;
a selection unit configured to select one motion vector from the plurality of motion vectors such that reducing a code amount when the selected motion vector is encoded and reducing the difference corresponding to the selected motion vector are achieved in predetermined balance; and
an encoding unit configured to encode the motion vector selected by said selection unit and the difference calculated for the motion vector by said calculation unit,
wherein the predetermined balance gives priority to reducing the difference over reducing the code amount as a minimum value of a plurality of differences calculated by said calculation unit becomes smaller, and gives priority to reducing the code amount over reducing the difference as the minimum value becomes larger.

2. The apparatus according to claim 1, wherein
said selection unit comprises a coefficient selection unit configured to select a coefficient having a smaller value as the minimum value of the plurality of differences calculated by said calculation unit becomes smaller, and
said selection unit performs the selection so as to minimize a sum of a product of the coefficient and the code amount when the selected motion vector is encoded and the difference corresponding to the selected motion vector.

3. The apparatus according to claim 1, further comprising a detection unit configured to detect a degree of variation between pixels of the encoding target block image,
wherein said selection unit performs the selection while weakening the priority tendency of the predetermined balance as the degree of variation becomes smaller.

4. The apparatus according to claim 1, wherein said selection unit comprises:
a candidate selection unit configured to select, for each of a plurality of coefficients having different values, one motion vector from the plurality of motion vectors as a candidate vector such that a sum of a product of the coefficient and the code amount when the selected motion vector is encoded and the difference corresponding to the selected motion vector is minimized; and
a decision unit configured to decide, as the one motion vector to be selected by said selection unit, the candidate vector selected by said candidate selection unit in correspondence with a coefficient having a smaller value out of the plurality of coefficients as the minimum value of the plurality of differences calculated by said calculation unit becomes smaller.

5. A moving image encoding apparatus for performing motion compensation prediction encoding for an encoding target block image existing at a predetermined position of an encoding target image using one motion vector selected from a plurality of motion vectors serving as candidates, comprising:
a first calculation unit configured to, for each of the plurality of motion vectors, reduce the encoding target block image and a reference block image which exists at a position moved based on the motion vector from a position in a reference image corresponding to the predetermined position and calculate a difference between the reduced block image and the reduced reference block image;
a first selection unit configured to select one motion vector from the plurality of motion vectors such that reducing a code amount when the selected motion vector is encoded and reducing the difference corresponding to the selected motion vector are achieved in first balance;
a second calculation unit configured to calculate, for, out of the plurality of motion vectors, each of the motion vectors whose distances from a position indicated by the motion vector selected by said first selection unit are equal to or smaller than a threshold, a difference between the block image and the reference block image;
a second selection unit configured to select one motion vector from the motion vectors whose distances from the position indicated by the motion vector selected by said first selection unit are equal to or smaller than the threshold such that reducing the code amount when the selected motion vector is encoded and reducing the difference corresponding to the selected motion vector are achieved in second balance; and
an encoding unit configured to encode the motion vector selected by said second selection unit and the difference calculated for the motion vector by said second calculation unit,
wherein the first balance gives priority to reducing the difference over reducing the code amount as a minimum value of a plurality of differences calculated by said first calculation unit becomes smaller, and gives priority to reducing the code amount over reducing the difference as the minimum value becomes larger.

6. A method of controlling a moving image encoding apparatus for performing motion compensation prediction encoding for an encoding target block image existing at a predetermined position of an encoding target image using one motion vector selected from a plurality of motion vectors serving as candidates, comprising:
a calculation step of calculating, for each of the plurality of motion vectors, a difference between the encoding target block image and a reference block image which exists at a position moved based on the motion vector from a position in a reference image corresponding to the predetermined position;
a selection step of selecting one motion vector from the plurality of motion vectors such that reducing a code amount when the selected motion vector is encoded and reducing the difference corresponding to the selected motion vector are achieved in predetermined balance; and
an encoding step of encoding the motion vector selected in the selection step and the difference calculated for the motion vector in the calculation step,
wherein the predetermined balance gives priority to reducing the difference over reducing the code amount as a minimum value of a plurality of differences calculated in the calculation step becomes smaller, and gives priority to reducing the code amount over reducing the difference as the minimum value becomes larger.

7. A method of controlling a moving image encoding apparatus for performing motion compensation prediction encoding for an encoding target block image existing at a predetermined position of an encoding target image using one motion vector selected from a plurality of motion vectors serving as candidates, comprising:
a first calculation step of, for each of the plurality of motion vectors, reducing the encoding target block image and a reference block image which exists at a position moved based on the motion vector from a position in a reference image corresponding to the predetermined position and calculating a difference between the reduced block image and the reduced reference block image;
a first selection step of selecting one motion vector from the plurality of motion vectors such that reducing a code amount when the selected motion vector is encoded and reducing the difference corresponding to the selected motion vector are achieved in first balance;
a second calculation step of calculating, for, out of the plurality of motion vectors, each of motion vectors whose distances from a position indicated by the motion vector selected in the first selection step are equal to or smaller than a threshold, a difference between the block image and the reference block image;
a second selection step of selecting one motion vector from the motion vectors whose distances from the position indicated by the motion vector selected in the first selection step are equal to or smaller than the threshold such that reducing the code amount when the selected motion vector is encoded and reducing the difference corresponding to the selected motion vector are achieved in second balance; and
an encoding step of encoding the motion vector selected in the second selection step and the difference calculated for the motion vector in the second calculation step,
wherein the first balance gives priority to reducing the difference over reducing the code amount as a minimum value of a plurality of differences calculated in the first calculation step becomes smaller, and gives priority to reducing the code amount over reducing the difference as the minimum value becomes larger.

8. A non-transitory computer readable storage medium storing a program for causing a computer to execute steps of the control method of claim 6.

9. A non-transitory computer readable storage medium storing a program for causing a computer to execute steps of the control method of claim 7.
